(19) United States
(12) Patent Application Publication
(10) Pub. No.: US 2025/0218685 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Young Eun KIM, Suwon-si (KR); Jea Yeol CHOI, Suwon-si (KR); Young Ghyu AHN, Suwon-si (KR); Joon Yeob CHO, Suwon-si (KR)

(73) Assignee: SAMSUNG ELECTRO-MECHANICS CO., LTD., Suwon-si (KR)

(21) Appl. No.: 18/951,985

(22) Filed: Nov. 19, 2024

(30) Foreign Application Priority Data
Dec. 27, 2023 (KR) 10-2023-0193108

(51) Int. Cl. H01G 4/30; H01G 2/06; H01G 4/008; H01G 4/012; H01G 4/12; H01G 4/224

(52) U.S. Cl. CPC H01G 4/30; H01G 2/065; H01G 4/008; H01G 4/012; H01G 4/12; H01G 4/224

(57) ABSTRACT

A multilayer electronic component includes: a body including first and second surfaces opposing in a first direction, third and fourth surfaces opposing in a second direction, and fifth and sixth surfaces opposing in a third direction, and including a capacitance formation portion including a dielectric layer and internal electrodes arranged in the first direction, cover portions on the capacitance formation portion in the first direction, and side margin portions on the capacitance formation portion and the cover portions in the third direction; and external electrodes on the third and fourth surfaces. In a first and third directional cross-section of the body, one or more IPs, a point at which an inclination of a tangent to an outer surface of the body is opposite, is disposed in one or more corner regions. W<T<L, where T, L, and W are thickness, length, and width of the body, respectively.

### CROSS-REFERENCE TO RELATED APPLICATION(S)

This application claims benefit of priority to Korean Patent Application No. 10-2023-0193108 filed on Dec. 27, 2023, in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic product, such as image display devices including a liquid crystal display (LCD) and a plasma display panel (PDP), computers, smartphones and mobile phones, and serves to charge electricity therein or discharge electricity therefrom.

The multilayer ceramic capacitor may be used as a component in various electronic devices due to having a small size, ensuring high capacitance and being easily mounted. With the miniaturization and implementation of high output power of various electronic devices such as computers and mobile devices, demand for miniaturization and high capacitance of multilayer ceramic capacitors has also been increasing.

In general, MLCCs have a structure having the same width and thickness. In order to achieve high capacitance, it is necessary to increase the number of layers by thinning a dielectric layer and internal electrodes. However, due to technical limitations in thinning the dielectric layer and internal electrodes, it may not be easy to implement a high number of stacked layers with a structure having the same width and thickness of a chip. Accordingly, High-Profile Ceramic Capacitor (HPCC) products implementing a high number of layers by increasing a thickness of the chip have been developed.

Since the HPCC has a structure in which a thickness T thereof is thicker than a width W thereof, the HPCC may increase the number of layers as compared to general MLCCs having the same width and thickness, and may easily achieve high capacitance.

Since the number of layers in the HPCC is increased compared to general MLCCs, the contact properties between the internal electrode and the external electrode are one of the factors significantly affecting reliability.

### SUMMARY

An aspect of the present disclosure is to provide a multilayer electronic component having excellent reliability.

An aspect of the present disclosure is to provide a multilayer electronic component having improved contact properties between internal electrodes and external electrodes.

An aspect of the present disclosure is to provide a multilayer electronic component having low equivalent series resistance (ESR).

An aspect of the present disclosure is to provide a multilayer electronic component that is compact and has excellent capacitance.

However, the aspects of the present disclosure are not limited to the above-described contents, and may be more easily understood in the process of describing specific embodiments of the present disclosure.

A multilayer electronic component according to an example embodiment of the present disclosure may include: a body including first and second surfaces opposing each other in a first direction, third and fourth surfaces connected to the first and second surfaces and opposing each other in a second direction, and fifth and sixth surfaces connected to the first to fourth surfaces and opposing each other in a third direction, and including a capacitance formation portion including a dielectric layer and internal electrodes alternately arranged with the dielectric layer in the first direction, cover portions disposed on both surfaces of the capacitance formation portion in the first direction, and side margin portions disposed on both surfaces of the capacitance formation portion and the cover portions in the third direction; and external electrodes disposed on the third and fourth surfaces, and in first and third directional cross-sections of the body. One or more IPs, a point at which an inclination of a tangent to an outer surface of the body is opposite, is disposed on an exterior surface of one or more corner regions of the body. W<T<L is satisfied, in which T is a thickness of the body in the first direction, L is a length of the body in the second direction, and W is a width of the body in the third direction.

One of the various effects of the present disclosure is to improve the reliability of a multilayer electronic component.

One of the various effects of the present disclosure is to improve the contact properties between internal electrodes and external electrodes.

One of the various effects of the present disclosure is to provide a multilayer electronic component having low equivalent series resistance (ESR).

One of the various effects of the present disclosure is to provide a multilayer electronic component that is compact and has excellent capacitance.

However, advantages and effects of the present application are not limited to the foregoing content and may be more easily understood in the process of describing a specific example embodiment of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic perspective view of a body according to an example embodiment of the present disclosure;

FIG. 3 is a schematic view of the body of FIG. 2 excluding a side margin portion;

FIG. 4 is a schematic cross-sectional view taken along line I-I′ of FIG. 1;

FIG. 5 is a schematic cross-sectional view taken along line II-II′ of FIG. 1;

FIG. 6 is an enlarged view of region K1 of FIG. 5;

FIG. 7 is a view corresponding to FIG. 6 according to another example embodiment;

FIG. 8 is a view corresponding to FIG. 6 according to another example embodiment;

FIG. 9 is a view of a substrate on which the multilayer electronic component of FIG. 1 is mounted.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. Therefore, in the drawings, the shapes and dimensions of elements may be exaggerated for clarity, and the same reference numerals will be used throughout to designate the same or like elements.

In addition, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. In addition, components with the same function within the same range of ideas are described using the same reference numerals. Throughout the specification, when a certain portion “includes” or “comprises” a certain component, this indicates that other components are not excluded and may be further included unless otherwise noted.

In the drawings, a first direction may be defined as a thickness T direction, a second direction may be defined as a length L direction, and a third direction may be defined as a width W direction.

### Multilayer Electronic Component

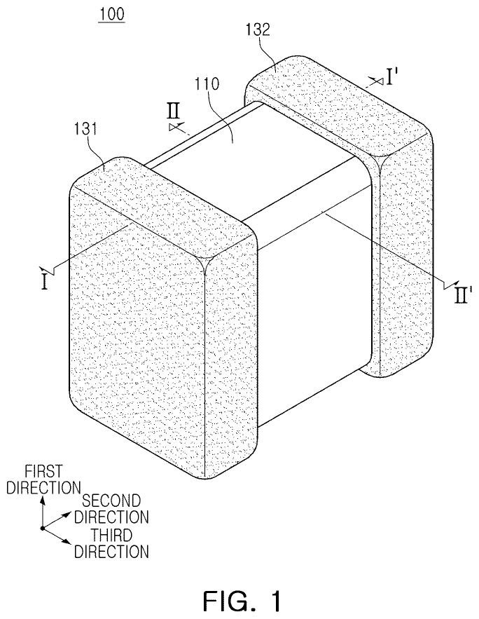

FIG. 1 is a schematic perspective view of a multilayer electronic component according to an example embodiment of the present disclosure.

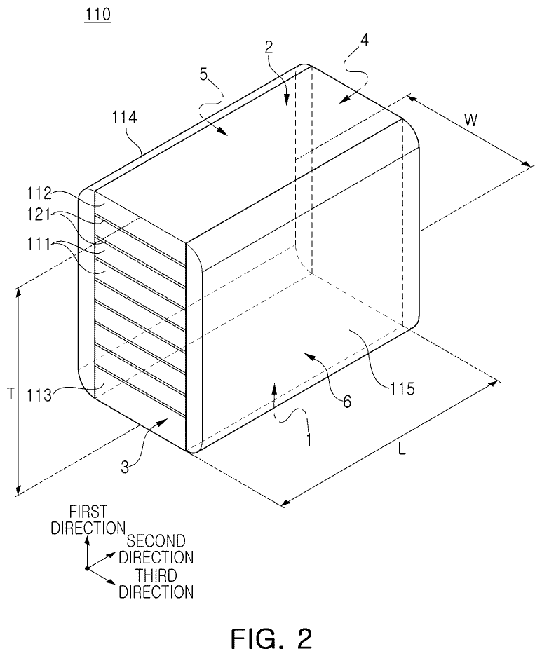

FIG. 2 is a schematic perspective view of a body according to an example embodiment of the present disclosure.

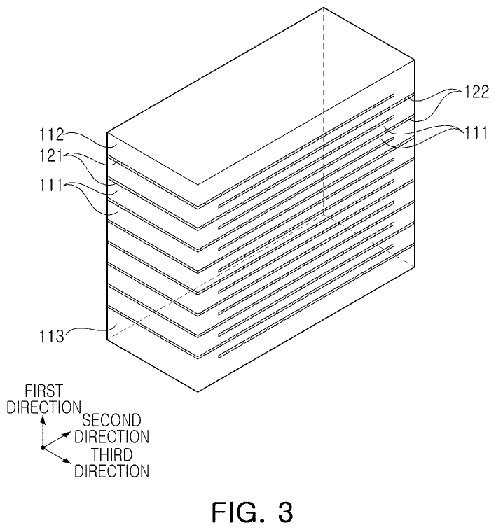

FIG. 3 is a schematic view of the body of FIG. 2 excluding a side margin portion.

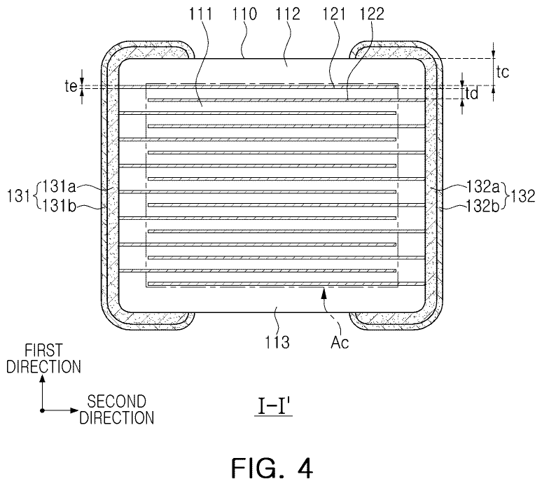

FIG. 4 is a schematic cross-sectional view taken along line I-I′ of FIG. 1.

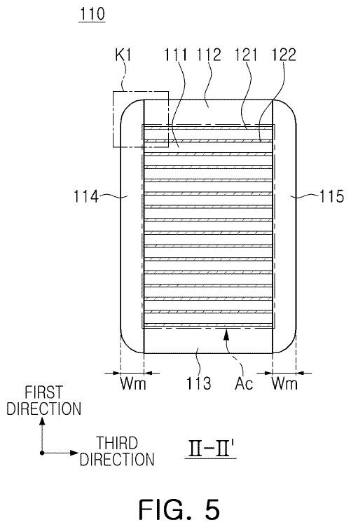

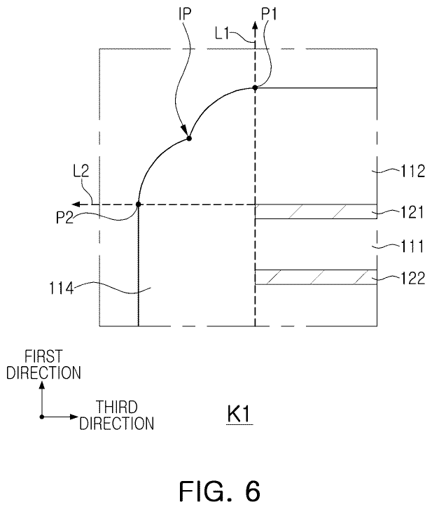

FIG. 5 is a schematic cross-sectional view taken along line II-II′ of FIG. 1. FIG. 6 is an enlarged view of region K1 of FIG. 5.

Hereinafter, a multilayer electronic component 100 according to an example embodiment of the present disclosure will be described in detail with reference to FIGS. 1 to 6. Additionally, a multilayer ceramic capacitor (hereinafter referred to as ‘MLCC’) is described as an example of a multilayer electronic component, but the present disclosure is not limited thereto, and the multilayer electronic component of the present disclosure may also be applied to various multilayer electronic components using ceramic materials, such as inductors, piezoelectric elements, varistors, or thermistors.

According to an example embodiment of the present disclosure, a multilayer electronic component 100 may include: a body 110 including first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first to fourth surfaces 1 to 4 and opposing each other in a third direction, and including a capacitance formation portion Ac including a dielectric layer 111 and internal electrodes 121 and 122 alternately arranged with the dielectric layer in the first direction, cover portions 112 and 113 disposed on both surfaces of the capacitance formation portion in the first direction, and side margin portions 114 and 115 disposed on both surfaces of the capacitance formation portion Ac and the cover portions in the third direction; and external electrodes 131 and 132 disposed on the third and fourth surfaces 3 and 4, and in first and third directional cross-sections of the body, one or more IPs, a point at which an inclination of a tangent to an outer surface of the body is opposite, may be disposed in one or more corner regions, and when a thickness (e.g., a maximum thickness or an average thickness) of the body in the first direction is referred to as T, a length (e.g., a maximum length or an average length) of the body in the second direction is referred to as L, and a width (e.g., a maximum width or an average width) of the body in the third direction is referred to as W, W<T<L may be satisfied. A dimension (i.e., the thickness in the first direction, the length in the second direction, and/or the width in the third direction) of the body 110 may be measured with a microscope based on a cross-section (e.g., the cross-section shown in FIG. 4 or 5) of the body 110 cut through a central portion of the body 110. In one example, the dimension (i.e., the thickness in the first direction, the length in the second direction, and/or the width in the third direction) of the body 110 may be measured along a center line in a corresponding direction of the first to third directions of the body 110. An average dimension (i.e., the average thickness in the first direction, the average length in the second direction, and/or the average width in the third direction) of the body 110 may be obtained by measuring the corresponding dimension at multiple points, for example, 30 points equally spaced apart from each other, and measuring an average value thereof. A maximum dimension (i.e., the maximum thickness in the first direction, the maximum length in the second direction, and/or the maximum width in the third direction) of the body 110 may be obtained by selecting the maximum value among those obtained at multiple points, for example, 30 points equally spaced apart from each other.

According to an example embodiment, one or more IPs, a point at which an inclination of a tangent to an outer surface of the body is opposite, may be disposed in one or more corner regions of body 110, and when a maximum thickness of the body in the first direction is referred to as T, a maximum length of the body in the second direction is referred to as L, and a maximum width of the body in the third direction is referred to as W, W<T<L may be satisfied, and accordingly, the contact properties between the electrodes and the external electrodes may be improved, and high capacitance may be secured.

Hereinafter, each component included in the multilayer electronic component 100 according to an example embodiment of the present disclosure will be described.

The body 110 may have dielectric layers 111 and internal electrodes 121 and 122 alternately stacked.

There is no particular limitation on the specific shape of the body 110, but as illustrated, the body 110 may have a hexahedral shape or a shape similar thereto. Due to contraction of ceramic powder particles included in the body 110 during a sintering process, the body 110 may not have a hexahedral shape with entirely virtual lines.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first and second surfaces 1 and 2 and connected to the third and fourth surfaces 3 and 4 and opposing each other in the third direction.

In a state in which a plurality of dielectric layers 111 included in the body 110 are sintered, boundaries between adjacent dielectric layers 111 may be integrated so as to be difficult to identify without using a scanning electron microscope (SEM). The number of dielectric layers is not particularly limited, and may be determined by considering the size of the multilayer electronic component. For example, the body may be formed by stacking 400 or more dielectric layers.

The dielectric layer 111 may be formed by producing a ceramic slurry containing ceramic powder particles, an organic solvent and a binder, applying the slurry to a carrier film and drying the slurry thereon to prepare a ceramic green sheet, and then sintering the ceramic green sheet. The ceramic powder particles are not particularly limited as long as sufficient electrostatic capacitance may be obtained therewith, and for example, barium titanate-based (BaTiO₃) powder particles, CaZrO₃-based paraelectric powder particles, and the like, may be used as the ceramic powder particles. For more specific examples, the barium titanate (BaTiO₃) powder particles may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1), and the CaZrO₃-based paraelectric powder particles may be (Ca₁₋ₓSrₓ)(Zr_{1-y}Ti_{y})O₃ (0<x<1, 0<y<1).

Therefore, the dielectric layer 111 may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1) and (Ca₁₋ₓSrₓ)(Zr_{1-y}Ti_{y})O₃ (0<x<1, 0<y<1).

The body 110 may include the capacitance formation portion Ac disposed in the body 110 and including a first internal electrode 121 and a second internal electrode 122 disposed so as to face each other with the dielectric layer 111 interposed therebetween to form capacitance, and cover portions 112 and 113 formed on upper and lower portions of the capacitance formation portion Ac in the first direction.

Additionally, the capacitance formation portion Ac is a portion contributing to the capacitance formation of the capacitor, and may be formed by repeatedly stacking a plurality of first and second internal electrodes 121 and 122 with the dielectric layer 111 interposed therebetween.

The cover portions 112 and 113 may include a first cover portion 112 disposed above the capacitance formation portion Ac in the first direction and a second cover portion 113 disposed below the capacitance formation portion Ac in the first direction. The first cover portion 112 may be referred to as an upper cover portion, and the second cover portion 113 may be referred to as a lower cover portion.

The first upper cover portion 112 and the second cover portion 113 may be formed by stacking a single dielectric layer or two or more dielectric layers on upper and lower surfaces of the capacitance formation portion Ac in a thickness direction, respectively, and may basically serve to prevent damage to the internal electrodes due to physical or chemical stress.

The first cover portion 112 and the second cover portion 113 may not include an internal electrode, and may include the same material as the dielectric layer 111.

That is, the first cover portion 112 and the second cover portion 113 may include a ceramic material, and may include, for example, a barium titanate (BaTiO₃) ceramic material.

Meanwhile, the thicknesses of the cover portions 112 and 113 are not particularly limited. However, in order to more easily achieve miniaturization and high capacitance of a multilayer electronic component, a thickness tc of the cover portions 112 and 113 may be 20 μm or less. Additionally, when the size of the multilayer electronic component 100 is 0402 (length: 0.4 mm, width: 0.2 mm), the thickness tc of the cover portions 112 and 113 may be 18 μm or less.

An average thickness tc of the cover portions 112 and 113 may refer to a first directional size, and may be an average value of the first directional sizes of the cover portions 112 and 113 measured at five points equally spaced apart from each other in an upper portion or a lower portion of the capacitance formation portion Ac.

The side margin portions 114 and 115 may be disposed on both surfaces of the capacitance formation portion Ac and the cover portions 112 and 113 in the third direction.

The side margin portions 114 and 115 may include a first side margin portion 114 disposed on one surface of the capacitance formation portion Ac and the cover portions 112 and 113 in the third direction and a second side margin portion 115 disposed on the other surface thereof in the third direction.

The side margin portions 114 and 115 may be formed by stacking ceramic green sheets and ceramic green sheets on which internal electrode patterns are printed and performing a sintering process on the stacked ceramic green sheets and then forming a stack body that becomes the capacitance formation portion Ac and the cover portions 112 and 113, and stacking one or more ceramic green sheets on both third directional surfaces of the stack body in the third direction.

The side margin portions 114 and 115 may basically serve to prevent damage to the internal electrodes due to physical or chemical stress.

Meanwhile, widths of the side margin portions 114 and 115 do not need to be particularly limited. However, in order to more easily achieve miniaturization and high capacitance of the multilayer electronic component, an average width Wm of the side margin portions 114 and 115 may be 17 μm or less.

The average width Wm of the side margin portions 114 and 115 may refer to an average size of a region in which the internal electrodes 121 and 122 are spaced apart from the fifth surface, in third direction, and an average size of a region in which the internal electrodes 121 and 122 are spaced apart from the sixth surface, in the third direction, and the average width Wm may be an average value of third directional sizes of the margin portions 114 and 115 measured at five points spaced apart from each other by equal intervals in the first direction on a side surface of the capacitance forming portion Ac.

Accordingly, in an example embodiment, the average sizes of regions in which the internal electrodes 121 and 122 are spaced from the fifth and sixth surfaces, in the third direction, may be 17 μm or less, respectively.

The internal electrodes 121 and 122 may include first and second internal electrodes 121 and 122. The first and second internal electrodes 121 and 122 may be alternately arranged to face each other with the dielectric layer 111 included in the body 110 interposed therebetween, and may be exposed to the third and fourth surfaces 3 and 4 of the body 110, respectively.

The first internal electrode 121 may be spaced apart from the fourth surface 4 and may be exposed through the third surface 3, and the second internal electrode 122 may be spaced apart from the third surface 3 and may be exposed through the fourth surface 4. The first external electrode 131 may be disposed on the third surface 3 of the body and may be connected to the first internal electrode 121, and the second external electrode 132 may be disposed on the fourth surface 4 of the body and may be connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. Accordingly, the first internal electrode 121 may be formed to be spaced apart from the fourth surface 4 by a certain distance, and the second internal electrode 122 may be formed to be spaced apart from the third surface 3 by a certain distance.

Additionally, the first and second internal electrodes 121 and 122 may be spaced apart from the fifth and sixth surfaces of the body 110. Both ends of the first and second internal electrodes 121 and 122 in the third direction may be in contact with the side margin portions 114 and 115.

A conductive metal included in the internal electrodes 121 and 122 may be one or more of Ni, Cu, Pd, Ag, Au, Pt, In, Sn, Al, Ti, and alloys thereof, and the present disclosure is not limited thereto.

An average thickness td of the dielectric layer 111 is not specifically limited, but may be, for example, 0.1 μm to 10 μm. An average thickness te of the internal electrodes 121 and 122 is not specifically limited, but may be, for example, 0.05 μm to 3.0 μm. Additionally, the average thickness td of the dielectric layer 111 and the average thickness te of the internal electrodes 121 and 122 may be arbitrarily set according to the desired characteristics or purposes. For example, in order to achieve miniaturization and high capacitance, the dielectric layer 111 may have an average thickness td of 0.45 μm or less, and the internal electrodes 121 and 122 may have an average thickness te of 0.45 μm or less.

Each of the average thickness td of the dielectric layer 111 and the average thickness te of the internal electrodes 121 and 122 refer to the first directional sizes of the dielectric layer 111 and the internal electrodes 121 and 122. The average thickness td of the dielectric layer 111 and the average thickness te of the internal electrodes 121 and 122 may be measured by scanning images of first and second directional cross-sections of the body 110 with a scanning electron microscope (SEM) of 10,000× magnification. More specifically, the average thickness td of the dielectric layer 111 may be obtained by measuring the thicknesses thereof at multiple points of one dielectric layer 111, for example, 30 points equally spaced apart from each other in the second direction, and measuring an average value thereof. Additionally, the average thickness te of the internal electrodes 121 and 122 may be obtained by measuring the thicknesses at multiple points of one internal electrode 121 or 122, for example, 30 points equally spaced apart from each other in the second direction, and measuring an average value thereof. The 30 points equally spaced apart from each other may be designated in the capacitance formation portion Ac. Meanwhile, when the average value is measured by extending an average value measurement up to each of 10 dielectric layers 111 and 10 internal electrodes 121 and 122, the average thickness td of the dielectric layer 111 and the average thickness te of the internal electrodes 121 and 122 may be further generalized.

The external electrodes 131 and 132 may be disposed on the third surface 3 and the fourth surface 4 of the body 110.

The external electrodes 131 and 132 may include first and second external electrodes 131 and 132 disposed on the third and fourth surfaces 3 and 4 of the body 110, respectively, and connected to the first and second internal electrodes 121 and 122, respectively.

Referring to FIG. 1, the external electrodes 131 and 132 may be disposed to cover both cross-sections of the side margin portions 114 and 115 in the second direction.

In an example embodiment, the structure in which the multilayer electronic component 100 has two external electrodes 131 and 132 is described, but the number or shape of the external electrodes 131 and 132 may be changed depending on the shape of the internal electrodes 121 and 122 or other purposes.

Meanwhile, the external electrodes 131 and 132 may be formed using any material that has electrical conductivity, such as a metal, and a specific material may be determined in consideration of electrical characteristics, structural stability, and the like, and further, the external electrodes 131 and 132 may have a multilayer structure.

For example, the external electrodes 131 and 132 may include an electrode layer disposed on the body 110 and a plating layer formed on the electrode layer.

For a more specific example of the electrode layer, the electrode layer may be a sintered electrode including a conductive metal and glass, or a resin-based electrode including a conductive metal and a resin.

Additionally, the electrode layer may be in the form in which the sintered electrode and the resin-based electrode are sequentially formed on the body. Additionally, the electrode layer may be formed by transferring a sheet including a conductive metal onto the body, or may be formed by transferring a sheet including the conductive metal onto the sintered electrode.

A material having excellent electrical conductivity may be used as the conductive metal included in the electrode layer, and is not particularly limited. For example, the conductive metal may be one or more of nickel (Ni), copper (Cu), and alloys thereof.

The plating layer serves to improve mounting characteristics. The type of the plating layer is not particularly limited, and the plating layer may be a plating layer including at least one of Ni, Sn, Pd, and alloys thereof, and may be formed of a plurality of layers.

For a more specific example of the plating layer, the plating layer may be a Ni plating layer or a Sn plating layer, may have a form in which the Ni plating layer and the Sn plating layer are sequentially formed on the electrode layer, and may have a form in which the Sn plating layer, the Ni plating layer, and the Sn plating layer are sequentially formed. Additionally, the plating layer may include a plurality of Ni plating layers and/or a plurality of Sn plating layers.

In the first and third directional cross-sections of the body 110, one or more IPs, a point at which an inclination of a tangent to an outer surface of the body is opposite, may be disposed in one or more corner regions. Accordingly, the bonding properties of the external electrodes 131 and 132 to the body may be improved, and the contact properties between the internal electrodes 121 and 122 and the external electrodes 131 and 132 may be improved. As the contact properties between the internal electrodes 121 and 122 and the external electrodes 131 and 132 is improved, equivalent series resistance (ESR) may be lowered.

Meanwhile, one of the four corner regions of the first and third directional cross-sections of the body 110 will be described, but the four corner regions include a case in which the IP is disposed in at least one corner region among the four corner regions in a symmetrical relationship.

In an example embodiment, the corner region may include a curved shape as illustrated in FIG. 5.

Referring to FIG. 6, which is an enlarged view of region K1 of FIG. 5, in an example embodiment, in a case in which, when a virtual line L1 is drawn from one third directional end of the internal electrode disposed in an uppermost portion in the first direction to an upper portion in the first direction, a point at which the virtual line L1 meets an outer surface of the body is referred to as P1, and when a virtual line L2 is drawn in the third direction from the third directional end of the internal electrode disposed in the uppermost portion in the first direction, a point at which the virtual line L2 meets the outer surface of the body is referred to as P2, the IP may be disposed between P1 and P2.

In an example embodiment, as illustrated in FIG. 6, only one IP may be disposed between P1 and P2. However, the present disclosure is not limited thereto, and two or more IPs may be disposed between P1 and P2.

Meanwhile, two or more IPs may be disposed in at least one corner region of the corner regions.

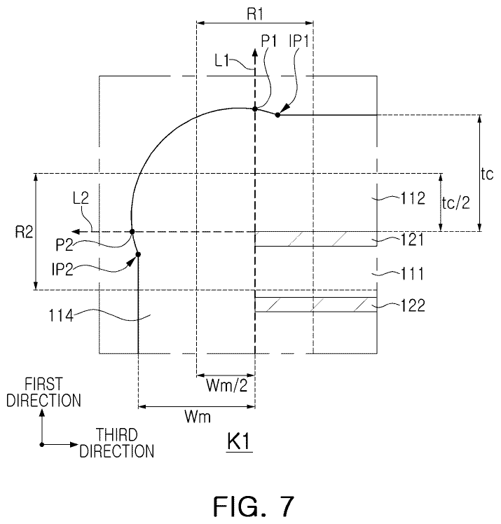

Referring to FIG. 7, which is a view corresponding to FIG. 6 according to another example embodiment, in a case in which, when the virtual line L1 is drawn from the third directional end of the internal electrode disposed in the uppermost portion in the first direction to the upper portion in the first direction, the point at which the virtual line L1 meets the outer surface of the body is referred to as P1, and when the virtual line L2 is drawn in the third direction from the third directional end of the internal electrode disposed in the uppermost portion in the first direction, the point at which the virtual line L2 meets the outer surface of the body is referred to as P2, when a region in half Wm/2 of the average width Wm of the side margin portion in the third direction from P1 is referred to as R1 and a region in half tc/2 of the average thickness tc of the cover portion in the first direction from P2 is referred to as R2, IP1 which is an IP disposed in the R1, and IP2 which is an IP disposed in the R2 may be included. That is, R1 may refer to a region between a point spaced apart from P1 by Wm/2 to one side in the third direction and a point spaced apart from P1 by Wm/2 to in the other side in the third direction, and a third directional size of R1 may be the same as a third directional size Wm of the side margin portion. Similarly, R2 may refer to a region between a point spaced apart by tc/2 from P2 to one side in the first direction and a point spaced apart by tc/2 from P2 to the other in the first direction, and the first directional size of R2 may be the same as a first directional size tc of the cover portion.

As one or more IPs are disposed in R1 and R2, respectively, the bonding properties of the external electrodes 131 and 132 to the body may be further improved, and the contact properties between the internal electrodes 121 and 122 and the external electrodes 131 and 132 may be further improved.

As illustrated in FIG. 7, IP1 may be disposed to overlap the capacitance formation portion Ac in the first direction, and IP2 may be disposed to overlap the capacitance formation portion Ac in the third direction.

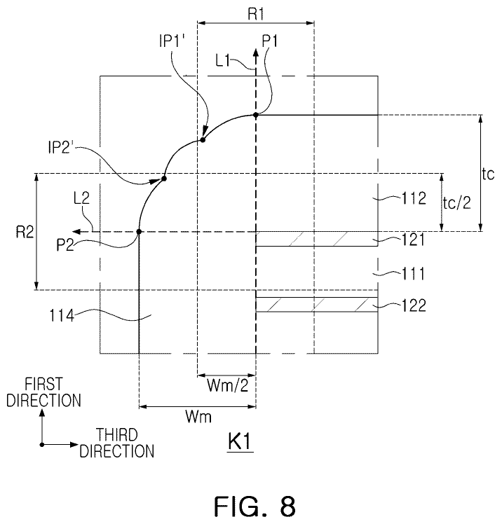

However, this is not limited thereto, and as illustrated in FIG. 8, which is a view corresponding to FIG. 6 according to another example embodiment, IP1 (IP1′) may be disposed to not overlap the capacitance formation portion Ac in the first direction, and IP2 (IP2′) may be disposed to not overlap the capacitance formation portion Ac in the third direction.

Alternatively, in an example embodiment, IP1 may be disposed to overlap the capacitance formation portion Ac in the first direction, and IP2 may be disposed to not overlap with the capacitance formation portion Ac in the third direction.

Alternatively, in an example embodiment, IP1 may be arranged to not overlap the capacitance formation portion Ac in the first direction, and IP2 may be disposed to overlap the capacitance formation portion Ac in the third direction.

In an example embodiment, only one IP may be disposed in each of R1 and R2.

Meanwhile, there is no need to specifically limit a method for forming IP in the corner region. As a preferred example, a shrinkage rate of the cover portion and the side margin portion may be controlled to control the position and number of IPs formed in the corner region. A sintering temperature, sintering time, and the like, of a sintering process may be controlled in a method of controlling the shrinkage rate of the cover portion and the side margin portion, and a composition of a ceramic green sheet for forming a cover portion and a ceramic green sheet for a side margin portion may be controlled.

Referring to FIG. 2, when a maximum thickness of the body 110 in the first direction is referred to as T, a maximum length of the body 110 in the second direction is referred to as L, and a maximum width of the body 110 in the third direction is referred to as W, W<T<L may be satisfied. As W<T is satisfied, the number of layers may be increased to easily secure high capacitance.

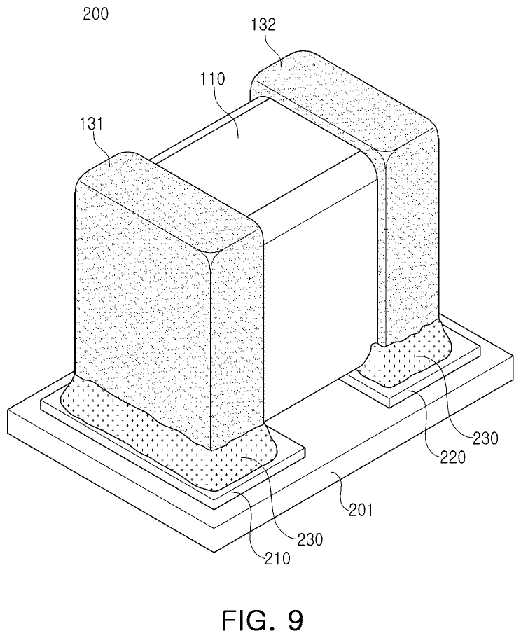

Referring to FIG. 9, which illustrates a substrate on which the multilayer electronic component of FIG. 1 is mounted, the multilayer electronic component may be mounted on the substrate by bonding the external electrodes 131 and 132 to a pair of electrode pads 210 and 220 disposed on the substrate 201 through a solder 230. Since there are less restrictions on T than on W and L, even if the number of layers is increased to increase T, high capacitance may be easily secured without significant restrictions.

In an example embodiment, the T and the W may satisfy 1.1<T/W<1.8. As 1.1<T/W is satisfied, high capacitance may be secured more easily, and as T/W<1.8 is satisfied, mounting reliability on the substrate may be stably secured.

When T/W is 1.1 or less, the effect of securing high capacitance according to an HPCC form may be insufficient, and when T/W is 1.8 or more, a thickness of the body becomes significantly thick as compared to a width thereof, which may cause problems such as tilting when mounting the multilayer electronic component on the substrate.

There is no need to specifically limit the size of the multilayer electronic component 100.

However, effects of improving the bonding properties of the external electrodes 131 and 132 to the body and improving the contact properties between the internal electrodes 121 and 122 and the external electrodes 131 and 132 according to the present disclosure may become more remarkable as the size of the multilayer electronic component 100 is reduced.

Specifically, when the size of the multilayer electronic component 100 is 0603 (length: 0.6 mm, width: 0.3 mm) or less, the effect according to the present disclosure may be remarkable. In consideration of manufacturing errors, and the like, when a maximum length L of the body 110 in the second direction is 0.69 mm or less, and a maximum width W of the body 110 in the third direction is 0.39 mm or less, the effect according to the present disclosure may be more remarkable. In this case, a maximum thickness T of the body 110 in the first direction may be 0.55 mm or less.

For a more specific example, in a case in which the size of the multilayer electronic component 100 is 0603, when the maximum length L of the body 110 in the second direction is 0.51 to 0.69 mm, and the maximum width W of the body 110 in the third direction is 0.21 to 0.39 mm, the effect according to the present disclosure may be more remarkable. In this case, the maximum thickness T of the body 110 in the first direction may be 0.45 to 0.55 mm.

Here, the maximum length L of the body 110 in the second direction may refer to the maximum size of the body 110 in the second direction, the maximum width W of the body 110 in the third direction may refer to the maximum size of the body 110 in the third direction, and the maximum thickness T of the body 110 in the first direction may refer to the maximum size of the body 110 in the first direction.

Although the example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ used in the present disclosure does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A multilayer electronic component, comprising:
a body including first and second surfaces opposing each other in a first direction, third and fourth surfaces connected to the first and second surfaces and opposing each other in a second direction, and fifth and sixth surfaces connected to the first to fourth surfaces and opposing each other in a third direction, and including a capacitance formation portion including a dielectric layer and internal electrodes alternately arranged with the dielectric layer in the first direction, cover portions disposed on both surfaces of the capacitance formation portion in the first direction, and side margin portions disposed on both surfaces of the capacitance formation portion and the cover portions in the third direction; and
external electrodes disposed on the third and fourth surfaces,
wherein in a first and third directional cross-section of the body, one or more IPs, a point at which an inclination of a tangent to an outer surface of the body is opposite, is disposed on an exterior surface of one or more corner regions of the body, and
W<T<L is satisfied, in which T is a thickness of the body in the first direction, L is a length of the body in the second direction, and W is a width of the body in the third direction.

2. The multilayer electronic component according to claim 1, wherein the corner region includes a curved shape.

3. The multilayer electronic component according to claim 1, wherein in a case in which, when a virtual line is drawn from a third directional end of an internal electrode disposed in an uppermost portion in the first direction to an upper portion in the first direction, a point at which the virtual line meets the outer surface of the body is referred to as P1, and when a virtual line is drawn in the third direction from the third directional end of the internal electrode disposed in the uppermost portion in the first direction, a point at which the virtual line meets the outer surface of the body is referred to as P2,
the IP is disposed between P1 and P2.

4. The multilayer electronic component according to claim 3, wherein only one IP is disposed between P1 and P2.

5. The multilayer electronic component according to claim 3, wherein two or more IPs are disposed between P1 and P2.

6. The multilayer electronic component according to claim 1, wherein the two or more IPs are disposed in at least one corner region of the corner regions.

7. The multilayer electronic component according to claim 1, wherein in a case in which, when a virtual line is drawn from a third directional end of an internal electrode disposed in an uppermost portion in the first direction to an upper portion in the first direction, a point at which the virtual line meets the outer surface of the body is referred to as P1, and when a virtual line is drawn in the third direction from the third directional end of the internal electrode disposed in the uppermost portion in the first direction, a point at which the virtual line meets the outer surface of the body is referred to as P2, and
when a region in half an average width of the side margin portion in the third direction from P1 is referred to as R1, and a region in half an average thickness of the cover portion in the first direction from P2 is referred to as R2,
IP1, which is an IP disposed in the R1, and IP2, which is an IP disposed in the R2, are included.

8. The multilayer electronic component according to claim 7, wherein the IP1 is disposed to overlap the capacitance formation portion in the first direction, and
the IP2 is disposed to overlap the capacitance formation portion in the third direction.

9. The multilayer electronic component according to claim 7, wherein the IP1 is disposed to overlap one of the cover portions in the first direction, and
the IP2 is disposed to overlap one of the side margin portions in the third direction.

10. The multilayer electronic component according to claim 7, wherein only one IP is disposed in each of the R1 and R2.

11. The multilayer electronic component according to claim 1, wherein the T and the W satisfy 1.1<T/W<1.8.

12. The multilayer electronic component according to claim 1, wherein the L is 0.69 mm or less, and the W is 0.39 mm or less.

13. The multilayer electronic component according to claim 12, wherein the T is 0.55 mm or less.

14. The multilayer electronic component according to claim 1, wherein the thickness of the body refers to a maximum thickness of the body in the first direction, the length of the body refers to a maximum length of the body in the second direction, and the width of the body refers to a maximum width of the body in the third direction.

15. The multilayer electronic component according to claim 1, wherein the thickness of the body refers to an average thickness of the body in the first direction, the length of the body refers to an average length of the body in the second direction, and the width of the body refers to an average width of the body in the third direction.
